(19) United States
(12) Patent Application Publication
(10) Pub. No.: US 2018/0144538 A1
(43) Pub. Date: May 24, 2018

(54) METHOD AND APPARATUS FOR PERFORMING TILE-BASED RENDERING

(71) Applicant: SAMSUNG ELECTRONICS CO., LTD., SUWON-SI (KR)

(72) Inventors: MIN-KYU JEONG, YONGIN-SI (KR); JAE-DON LEE, YONGIN-SI (KR); KWON-TAEK KWON, HWASEONG-SI (KR); MIN-YOUNG SON, HWASEONG-SI (KR)

(21) Appl. No.: 15/606,849

(22) Filed: May 26, 2017

(30) Foreign Application Priority Data
Nov. 18, 2016 (KR) 10-2016-0154451

(51) Int. Cl. G06T 15/00; G06T 17/20; G06T 11/00

(52) U.S. Cl. CPC G06T 15/005; G06T 2200/04; G06T 11/001; G06T 17/20

(57) ABSTRACT

A method of performing tile-based rendering in a graphics processing apparatus may include: generating a bitstream representing a tile binning result by performing tile binning with initial tiles having initial sizes. A determining as to whether a primitive belonging to an initial tile additionally belongs to other initial tiles bordering the initial tile is made by using the generated bitstream. A determining of a rendering tile is made, in which the rendering tile has a dynamic size and is formed by at least one of the initial tiles that the primitive belongs to, based on a result of the determining of whether the primitive additionally belongs to the other initial tiles. Rendering is performed on the primitive included in the determined rendering tile by using the determined rendering tile.

### CROSS-REFERENCE TO RELATED APPLICATION

This application claims the benefit of Korean Patent Application No. 10-2016-0154451, filed on Nov. 18, 2016, in the Korean Intellectual Property Office, the disclosure of which is incorporated herein by reference herein.

### 1. TECHNICAL FIELD

The present disclosure relates to a method and an apparatus for tile-based rendering.

### 2. DISCUSSION OF THE RELATED ART

Rendering systems are apparatuses capable of performing graphics processing for displaying content, and may include, for example, personal computers (PCs), notebooks, video game consoles, and embedded-system devices such as smart phones, tablet devices, and wearable devices. In general, graphics processing apparatuses included in the rendering systems may transform graphics data corresponding to a two-dimensional (2D) or a three-dimensional (3D) object to 2D pixels and generate frames to be displayed.

Some devices may have a relatively low arithmetic operation processing capability and high electrical consumption. Moreover, embedded-system devices such as smart phones, tablet devices, and wearable devices may not have the same level of graphics processing capability as that of workstations such as PCs, notebooks, and video game consoles in terms of sufficient memory space and processing power. However, there continues to be an increase in the use of portable devices such as smart phones and tablet devices, and a frequency of users worldwide playing games via smart phones or tablet devices, or watching content such as movies and dramas, has rapidly increased. Accordingly, to keep up with user demand, manufacturers of graphics processing devices have conducted much research on enhancing the capability and processing efficiency of graphic processing devices included in the embedded-system devices.

### SUMMARY

The inventive concept provides at least a method and an apparatus for tile-based rendering.

At least one embodiment of the inventive concept will be set forth in the description herein below that will be understood by a person of ordinary skill in the art, and/or may be learned by practice of the at least one embodiment.

According to an embodiment of the inventive concept, provided is a method of performing tile-based rendering in a graphics processing apparatus. The method may include: performing tile binning with a plurality of initial tiles having initial sizes and generating a bitstream representing a result of the tile binning; determining, based on the generated bit stream, whether a primitive belonging to a first initial tile of the plurality of initial tiles additionally belongs to other initial tiles bordering the first initial tile; determining a rendering tile, having a dynamic size, which is formed by at least one of the initial tiles that the primitive belongs to, based on a result of the whether the primitive additionally belongs other initial tiles bordering the first initial tile; and performing rendering on the primitive included in the determined rendering tile, per each of the at least one of the initial tiles determined to form the rendering tile.

According to an embodiment of the inventive concept, there is provided is a graphics processing apparatus performing tile-based rendering. The apparatus may include: an external memory wherein information about primitives is stored; and at least one processor configured to generate a bitstream representing a tile binning result by performing tile binning with respect to initial tiles having initial sizes, determine whether a primitive belonging to an initial tile belongs to other initial tiles around the initial tile by using the generated bitstream, determine a rendering tile, having a dynamic size, which is formed by at least one of the initial tiles that the primitive belongs to, based on a result of the firstly determining, and perform rendering on the primitive included in the determined rendering tile, per each determined rendering tile.

According to an embodiment of the inventive concept, there is provided is a non-transitory computer readable recording medium having recorded thereon a program for executing on a computer a method of performing tile-based rendering, according to an embodiment of the inventive concept.

According to an embodiment of the inventive concept, a graphics processing apparatus includes a graphics processing unit (GPU) having an on-chip memory and a graphics pipeline processor comprising a binning pipeline and a rendering pipeline; a central processing unit (CPU) that controls a graphics application programming interface (API) for the GPU; and an external memory connected to the GPU. The binning pipeline is configured to divide an image frame including a primitive into a plurality of initial tiles and determine which of the initial tiles includes the primitive therein, and generate bitstream information about each of the plurality of initial tiles; and the GPU renders the primitive included in the plurality of initial tiles and transforms a result of the rendering into pixel expressions.

According to an embodiment of the inventive concept, the on-chip memory may include a tile buffer in which the graphics pipeline processor stores the rendered primitive; and the rendering pipeline is configured to perform rendering for each of the initial tiles and to determine a rendering tile formed of at least one of the plurality of initial tiles to which the primitive belongs, wherein the rendering tile has a dynamic size that is adjustable based on a number of the initial tiles to which the primitive belongs and a capacity of the tile buffer.

The external memory includes a frame buffer that stores the image frame; and the GPU performs the rendering of the primitive based on a dynamic size information corresponding to the primitive, and stores only the initial tiles including the primitive in the frame buffer.

The GPU may further include a cache storage connected to the graphics pipeline processor, and when the cache stores information about a previously-rendered primitive, the GPU reads information from the cache and does not access the external memory.

### BRIEF DESCRIPTION OF THE DRAWINGS

The inventive will be understood and more readily appreciated by a person of ordinary skill in the art from the following description of the at least one embodiment, taken in conjunction with the accompanying drawings in which:

FIG. 1 is a block diagram of a computing apparatus performing tile-based rendering, according to an embodiment of the inventive concept;

FIG. 2 is a diagram illustrating graphics pipelines performing the tile-based rendering, according to an embodiment of the inventive concept;

FIG. 3 is a diagram illustrating a frame split into tiles, according to an embodiment of the inventive concept;

FIG. 4 is a diagram illustrating utilization of information about a primitive in a graphics pipeline processor, according to an embodiment of the inventive concept;

FIG. 5 is a diagram of a tile size determining unit of a graphics processing unit (GPU) performing the tile-based rendering, according to an embodiment of the inventive concept;

FIG. 6 is a diagram illustrating storing a rendered primitive in an external memory, according to an embodiment of the inventive concept;

FIG. 7 is a diagram illustrating the tile-based rendering performed in the GPU including a tile size determining unit, according to an embodiment of the inventive concept;

FIG. 8A is a diagram illustrating tiles and primitives for generating bitstreams, and FIG. 8B is a diagram illustrating bitstreams having information about primitives stored therein, according to an embodiment of the inventive concept;

FIG. 9 is a diagram illustrating determining a dynamic size corresponding to a rendering tile unit, according to an embodiment of the inventive concept;

FIG. 10 is a flowchart of a method of performing the tile-based rendering in the GPU, according to an embodiment of the inventive concept; and

FIG. 11 is a flowchart of a method of determining a rendering tile having a dynamic size in a tile size determining unit, according to an embodiment of the inventive concept.

### DETAILED DESCRIPTION

Reference will now be made in detail to at least one embodiment of the inventive concept, examples of which are illustrated in the accompanying drawings, wherein like reference numerals refer to like elements throughout. In this regard, the inventive concept may be practiced in different forms than shown and described herein, and the appended claims are not to be construed as being limited to the descriptions and illustrations set forth herein. Expressions used herein such as “at least one of,” when preceding a list of elements, modify the entire list of elements and do not modify the individual elements of the list.

Throughout the specification, when a described portion “includes” an element, another element may be further included, rather than excluding the existence of the other element, unless otherwise described. When a portion includes a composing element, the case may denote further including other composing elements without excluding other composing elements unless otherwise described. The terms “ . . . unit” or “module” are not to be construed as pure software, and may denote a unit performing one of specific operation or movement that may be realized by hardware, machine executable code loaded into a processor, or a combination of hardware and software.

Throughout the specification, the term “consists of” or “includes” should not be interpreted as meaning that all of various elements or steps described in the specification are absolutely included, and should be interpreted as meaning that some of elements or steps may not be included or that additional elements or steps may be further included.

While such terms as “first,” “second,” etc., may be used to describe various components, such components must not be limited to the above terms. The above terms are used only to distinguish one component from another.

Hereinafter, the inventive concept will be described more fully with reference to the accompanying drawings, in which exemplary embodiments of the inventive concept are shown. This inventive concept may, however, be embodied in many different forms and should not be construed as limited to the exemplary embodiments set forth herein. Rather, these embodiments are provided so that the inventive concept will be understood by person of ordinary skill in the art.

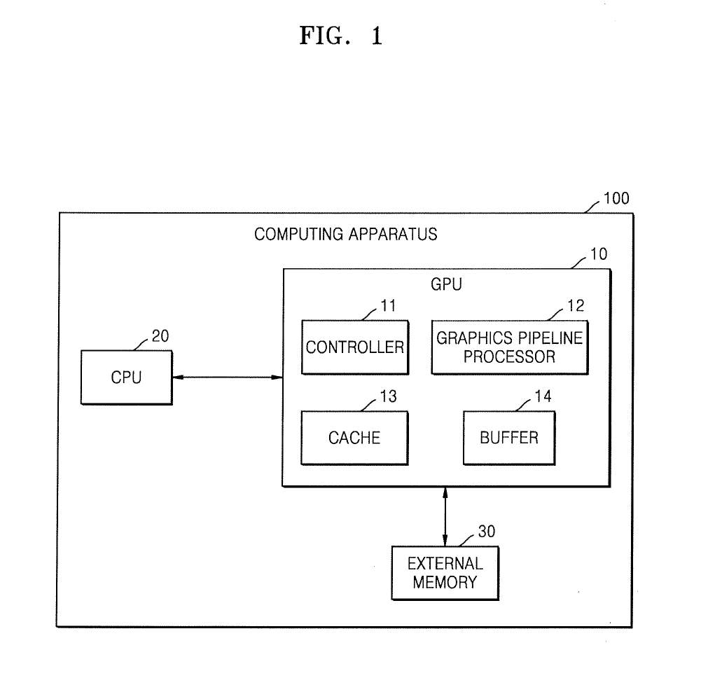

FIG. 1 is a block diagram of a computing apparatus 100 performing tile-based rendering, according to an embodiment of the inventive concept.

Referring to FIG. 1, the computing apparatus 100 may include a graphics processing unit (GPU) 10, a central processing unit (CPU) 20, and an external memory 30. Only components related to the present embodiment are illustrated in the computing apparatus 100 of FIG. 1. Thus, it will be understood by one of ordinary skill in the art that other conventional components may be further included in addition to the components illustrated in FIG. 1.

Some non-limiting examples of the computing apparatus 100 shown in FIG. 1 may be a desktop computer, a notebook computer, a smart phone, a personal digital assistant (PDA), a portable media player, a video game console, a television (TV) set-top box, a tablet device, an e-book reader, a wearable device, etc. However, the present embodiment of the inventive concept is not limited thereto. The computing apparatus 100, as an apparatus capable of graphics processing for displaying content, may include various devices.

The CPU 20 may be hardware controlling overall operations and functions of the computing apparatus 100. For example, the CPU 20 may drive an operating system (OS), call a graphics application programming interface (API) for the GPU 10, and execute a driver of the GPU 10. In addition, the CPU 20 may execute various applications stored in the memory 30 such as web browsing applications, game applications, and video applications.

The GPU 10 may be a dedicated graphics processor that executes (e.g. performs) graphics pipelines of various versions and kinds of programs, including but not in any way limited to open graphics library (OpenGL), DirectX, and compute unified device architecture (CUDA). The GPU 10 may be realized as hardware with structure to execute three-dimensional (3D) graphics pipelines for rendering a 3D image of a 3D object to a two-dimensional (2D) image for displaying. For example, the GPU 10 may perform various functions such as shading, blending, and illuminating, and other various functions for generating pixel values of pixels to be displayed.

The GPU 10 may include structure, (for example a tile/pipeline memory) that may assist in the performance of tile-based graphics pipelines or tile-based rendering (TBR). A plurality of graphics pipelines may be arranged in parallel for substantially simultaneous operations. The term “tile-based” may denote that each frame of a video image is divided into a plurality of tiles and then, rendering is performed on a per-tile basis. A tile-based architecture may need fewer arithmetic operations than processing a frame per pixel and thus, may be a graphics rendering method used in mobile devices (or embedded-system devices) such as smart phones and tablet devices which have a relatively slow processing capability. When the rendering is performed per tile, an operation of processing vertex information per tile and an operation of composing the frame by collecting tiles which have been divided after the operation of processing the vertex information for the tile unit may be added. However, the additional operations may reduce an amount of information loaded from the external memory 30 per tile. In addition, since a parallel processing per tile is possible due to independence between tiles, parallel processing efficiency may be enhanced.

The GPU 10 may receive a draw command from the CPU 20. The draw command may be a command specifying which object is to be rendered to an image or a frame. For example, the draw command may be a command for drawing a primitive included in the image or the frame. The primitive may denote a point, a line, a polygon, etc., which is formed by using at least one vertex. For example, the primitive may denote a triangle formed by connecting vertices.

The GPU 10 may include a controller 11, a graphics pipeline processor 12, a cache 13, and a buffer 14.

The controller 11 may receive at least one draw command for 3D graphics from the CPU 20. The controller 11 may control overall functions and operations of the graphics pipeline processor 12, the cache 13, and the buffer 14. A decoder (not shown) may decode instructions that the controller uses to control functions and operations of the graphics pipeline processor 12, the cache 13 and the buffer 14.

The graphics pipeline processor 12 may render 3D objects in 3D images to 2D images for display according to arrangements allocated for the graphics pipelines. When the graphics pipeline processor 12 performs the TBR, according to an embodiment of the inventive concept, the graphics pipeline processor 12 may divide each frame of a video image into a plurality of tiles and render the frame in units of a tile. The number of tiles per frame may be a predetermined number, or alternatively may be determined according to the complexity of the image.

The cache 13 may store graphics data included in the draw command received from the CPU 20 and graphics data received from the external memory 30. The graphics data may be data used for the rendering. For example, the graphics data may include source data such as coordinates information of the object, a texture type, and information about a camera viewpoint.

The buffer 14 may store a result of rendering the 3D objects in the 3D image to the 2D image for displaying. In the case of the TBR, the buffer 14 may store a rendering result per tile. The rendering result stored in the buffer 14 may also be stored in the external memory 30.

The external memory 30 may be hardware that stores various data processed in the computing apparatus 100, and may store data that is processed and data to be processed in the GPU 10. In addition, the external memory 30 may store, for example, applications, drivers, etc. to be driven by the GPU 10 and the CPU 20. The external memory 30 may include random access memory (RAM) such as dynamic random access memory (DRAM) and static random access memory (SRAM), read-only memory (ROM), electrically erasable programmable read-only memory (EEPROM), CD-ROMs, Blu-ray or other optical disc storages, hard disk drive (HDD), solid state drive (SSD), or flash memory, and may further include other external storage devices which the computing apparatus 100 can access. The rendering result stored in the buffer 14 of the GPU 10 may be stored in a frame buffer which is a storage space allocated in the external memory 30.

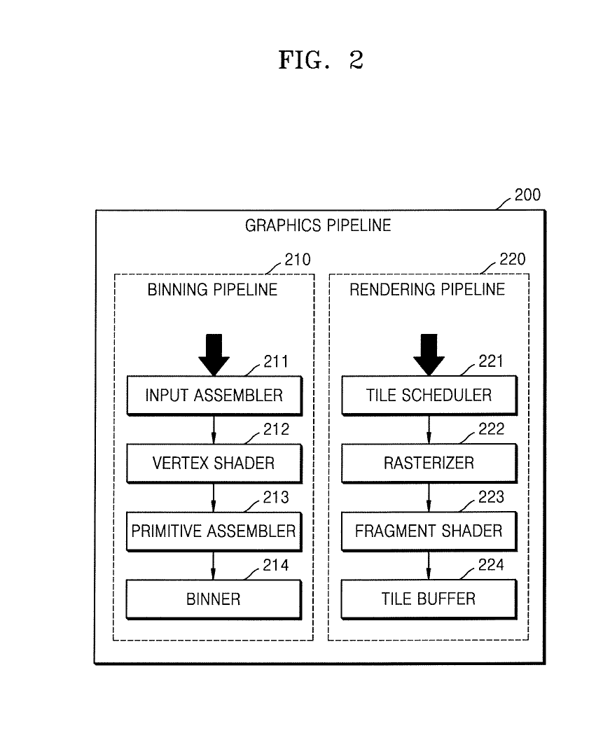

FIG. 2 is a diagram illustrating graphics pipelines performing the TBR, according to an embodiment of the inventive concept.

Referring to FIG. 2, a graphics pipeline 200 for the TBR may include, for example, a binning pipeline 210 generating information about a primitive list corresponding to respective tiles and a rendering pipeline 220 performing the rendering per tile by using information about the generated primitive list.

The binning pipeline 210 may include an input assembler (operation 211), a vertex shader (operation 212), a primitive assembler (operation 213), and a binner (operation 214).

In operation 211, the input assembler may generate vertices. The input assembler may generate vertices for displaying objects included in the 3D graphics, based on the draw command received from the CPU 20. The generated vertices may relate to a patch that is a representation of a mesh or a surface. However, the present embodiment is not limited to the aforementioned description.

In operation 212, the vertex shader may perform the shading for the vertices that may have been generated by the input assembler. The vertex shader may perform the shading for the generated vertices by specifying locations of the generated vertices.

In operation 213, the primitive assembler may transform the vertices to a plurality of primitives. The primitive may denote a point, a line, a polygon, etc. formed by using at least one vertex. As an example, the primitive may be expressed by a triangle formed by connecting a plurality of the vertices.

In operation 214, the binner may perform binning or tiling by using the primitives output from the primitive assembler in operation 213. For example, the binner may perform a depth test or a tile Z test and generate (or bin) a bitstream that represents information about tiles to which the primitives belong.

The rendering pipeline 220 may include, for example, a tile scheduler (operation 221), a rasterizer (operation 222), a fragment shader (operation 223), and a tile buffer (operation 224).

In operation 221, the tile scheduler may schedule a sequence of tiles to be processed, for the rendering pipeline 220 which is processed per tile.

In operation 222, the rasterizer may transform the primitives to pixel values in a 2D space, based on the generated tile list. Since the primitives include information for vertices only, the graphics processing for the 3D graphics may be performed by generating fragments between the vertices in operation 222.

In operation 223, the fragment shader may generate fragments and determine depth values, stencil values, color values, etc. of fragments. The fragments may denote pixels covered by the primitives.

In operation 224, a fragment shading result may be stored in the tile buffer.

In addition, rendering results generated in operations described above may be stored in one or more of the frame buffer and the storage space allocated in the external memory 30. In addition, the rendering results stored that are stored in the frame buffer may be displayed via a display apparatus as frames of a video image.

Operations included in the binning pipeline 210 and the rendering pipeline 220 are illustrated only for illustrative purposes, and the binning pipeline 210 and the rendering pipeline 220 may further include other well-known operations (for example, a tessellation pipeline, etc.). Nomenclatures for respective operations included in the binning pipeline 210 and the rendering pipeline 220 may vary depending on types of graphics APIs.

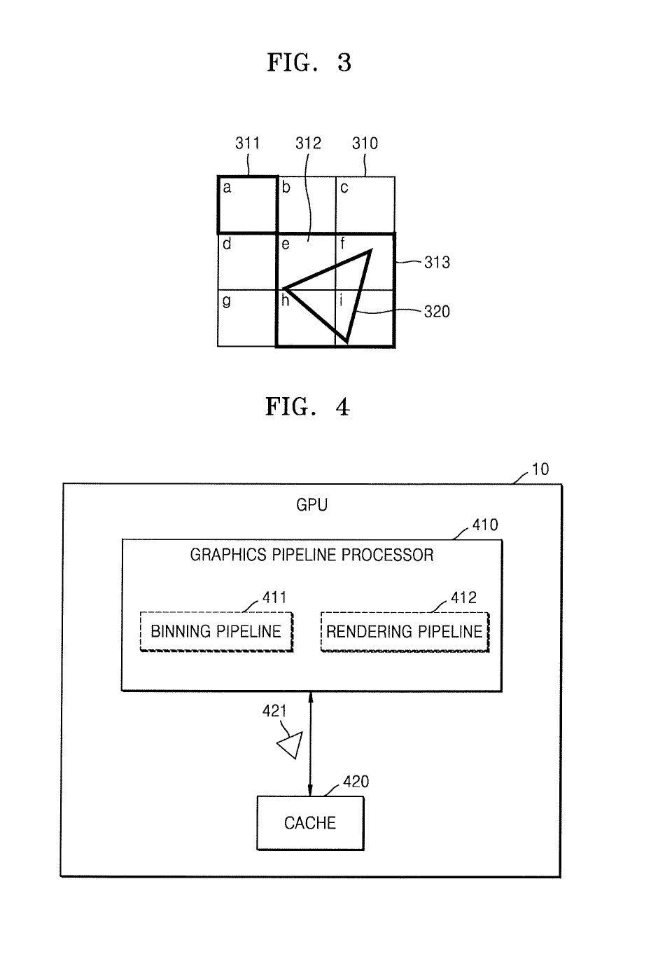

FIG. 3 is a diagram illustrating a frame split into tiles, according to an embodiment of the inventive concept.

Referring to FIG. 3, it is assumed that a certain frame 310 in a video image includes a primitive 320. The GPU 10 may divide the frame 310 including the primitive 320 into N×M (where N and M are natural numbers) tiles. Hereinafter, an initial tile may denote each of the smallest tiles dividing the frame 310 and an initial size may denote a size of the initial tile.

The binning pipeline 210 operation in FIG. 2 may divide the frame 310 including the primitive 320 into a plurality of initial tiles 311 and determine which of the initial tiles include the primitive 320 therein. The bitstream generated as a result of performing the binning pipeline 210 may include information about the primitive 320 in each of the initial tiles 311.

After the binning pipeline 210 operation has been performed, the GPU 10 may render the primitive 320 included in the initial tiles 311 per tile and transform a result of the rendering into pixel expressions. Rendering the primitive 320 per tile and transforming the result of the rendering into the pixel expressions may be performed by the rendering pipeline 220 such as shown in FIG. 2.

The rendering pipeline 220 may perform the rendering per tile having a certain size. A tile unit used in the rendering may vary in size. An entire or a portion of the primitive 320 may be rendered in the rendering pipeline 220 via a one-time rendering process depending on the tile unit and a combination of tiles. For example, one portion of the primitive 320 may be rendered by using a tile “e” (312) having an initial size as shown, while the entire portion of the primitive 320 may be rendered via the one-time rendering process by using a tile 313 formed by 2×2 tiles (for example, tiles e, f, h, and i). For example, in the example shown in FIG. 3, one tile unit for a first portion of the frame is the size of one tile 311, while another tile unit 313 in which the entire primitive is four square tiles (2 tiles by 2 tiles).

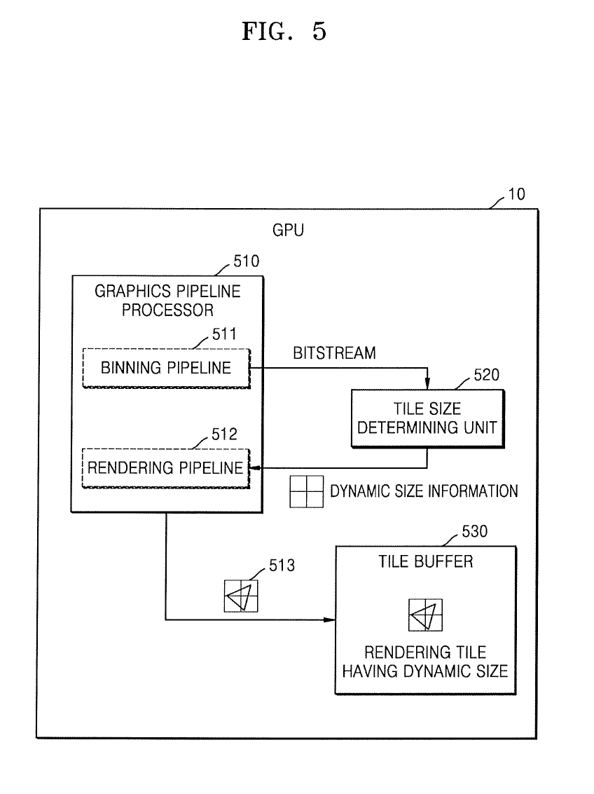

FIG. 4 is a diagram illustrating utilization of information about a primitive 421 in a graphics pipeline processor 410, according to an embodiment of the inventive concept.

The rendering pipeline 412 of the graphics pipeline processor 410 may perform the rendering by using bitstream information that was generated as a result of performing execution of the binning pipeline 411. The graphics pipeline processor 410 may use graphics data stored in the external memory 30 for rendering the primitives which are included in the tiles by performing execution of the rendering pipeline 412 per tile. The graphics data may include the information about the primitive 421, and the information about the primitive 421 may be source data such as coordinates and line information of the object.

A processing speed of the GPU 10 accessing the external memory 30 for rendering the primitives and reading the information about the primitive 421 may be slow when compared with operations that do not involve accessing the external memory. Accordingly, the GPU may access a cache 420, for example, an on-chip memory placed therein for enhancing the processing speed. The cache 420 may store the information about the primitive 421 that has been recently rendered by the graphics pipeline processor 410. When the information about the primitive 421 that is identical to the primitive previously rendered is requested, the graphics pipeline processor 410 may rapidly read the information about the primitive 421 by accessing the cache 420 rather than accessing the external memory 30.

However, a storage capacity of the cache 420 may be limited due to the characteristics of the on-chip memory. Accordingly, when the graphics pipeline processor 410 requests the cache 420 for information about a new primitive, information about an existing primitive stored in the cache 420 may be deleted and the cache 420 may be updated with the information about the new primitive read from the external memory 30. When only a portion of the primitive (hereinafter, the existing primitive) has been rendered as a result of the rendering, the information about the existing primitive stored in the cache 420 may have been deleted, at a point when the other portion of the existing primitive is rendered by updating the cache 420 with the information about the new primitive. Since the graphics pipeline processor 410 again will access the external memory 30 and read the information about the existing primitive for rendering the other portion of the existing primitive, a bandwidth may increase.

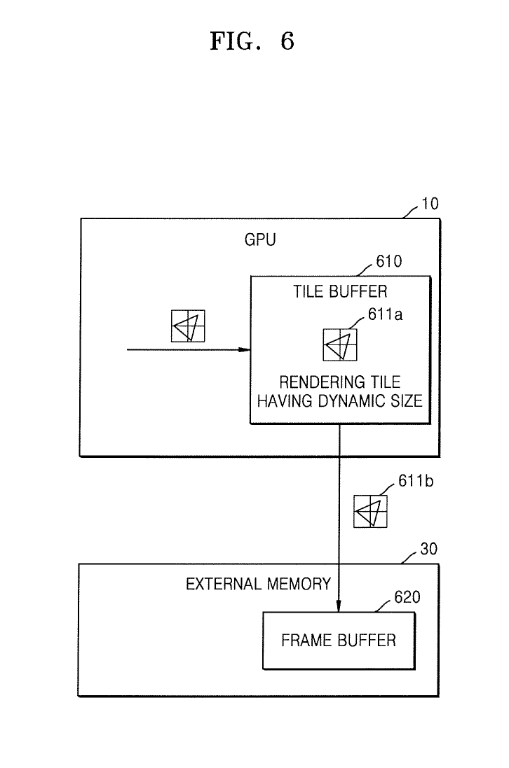

FIG. 5 is a diagram of a tile size determining unit 520 of the GPU 10 performing the TBR, according to an embodiment of the inventive concept.

Referring to FIG. 5, the bitstream representing a result of the tile binning operation may be generated after the tile binning has been performed per initial tile by dividing the frame in a binning pipeline 511 of a graphics pipeline processor 510. The bitstream may store information about each initial tile to which a primitive may belong.

The tile size determining unit 520 may determine whether the primitive belonging to an initial tile also belongs to other initial tiles in addition to the initial tile by using the generated bitstream. The initial tile may be one of the tiles which has the initial size by which the frame was divided.

The tile size determining unit 520 may determine a rendering tile which is formed of at least one of the initial tiles to which the primitive belongs, and has a dynamic size, based on a result of the determining. In addition, the tile size determining unit 520 may perform the rendering for the primitive included in the determined rendering tile per the determined rendering tile. Since sizes of primitives in the frame may be different from each other, the rendering tile having the dynamic size that may be variably determined depending on the number of the initial tiles to which the primitive belongs.

For example, when a first primitive belongs to only one initial tile, the dynamic size corresponding to the rendering tile unit performing the rendering on the first primitive may be the initial size of the one initial tile. In other words, the primitive is within the boundaries of one initial tile. Such a case may occur with a relatively small object, or if the vertex is a point, or a relatively small polygon, etc.

In addition, a second primitive may belong to a plurality of tiles having the initial tile size. For example, when the second primitive belongs to four tiles having the initial tile size, the second primitive may belong to not only the one initial tile but also three other initial tiles around the one initial tile. Thus, the dynamic size corresponding to the rendering tile unit performing the rendering for the second primitive may be formed of four tiles having the initial tile size.

The tile size determining unit 520 may provide to the graphics pipeline processor 510 information about the dynamic size corresponding to the rendering tile unit performing the rendering on the primitive. The information about the dynamic size may be, for example, information about a case when an identification value of the primitive matches the identification value of at least one initial tile to which the primitive belongs. However, the present embodiment of the inventive concept is not limited thereto. The graphics pipeline processor 510 may perform the rendering for respective primitives per the rendering tile units corresponding to respective primitives, based on the information about the dynamic size.

For example, when the rendering tile unit performing the rendering for the first primitive to which the initial tile belongs is one initial tile, the information about the dynamic size may be information about a case when the identification value of the first primitive matches the identification value of one initial tile to which the first primitive belongs. In addition, for example, when the rendering tile unit performing the rendering on the second primitive includes the initial tile having the initial tile size and three other initial tiles around (e.g. next to) the initial tile, the information about the dynamic size may be information about a case when the identification value of the second primitive matches the identification values of four tiles which the second primitive belongs to and have the initial tile size.

The rendering tile unit may vary which tile size is used when the rendering is performed in the rendering pipeline 512 of the graphics pipeline processor 510. The rendering pipeline 512 may perform the rendering on an entire portion or a portion of the primitive via the one-time rendering process depending on a size relationship between the primitive and the rendering tile unit. According to an embodiment of the inventive concept, the rendering tile unit performing the rendering may be the initial tile having the initial tile size. For example, when the first primitive belongs to one initial tile having the initial size, an entire portion of the first primitive may be rendered via a one-time rendering process by using the initial tile having the initial size. In addition, for example, when the second primitive belongs to four initial tiles having the initial tile size, only a portion of the second primitive may be rendered by the one-time rendering process by using the initial tile having the initial size.

The tile size determining unit 520 may determine a tile, having the dynamic size, to which an entire portion of the primitive can belong and provide the information about the determined dynamic size to the graphics pipeline processor 510. When the graphics pipeline processor 510 performs rendering on the primitive per the rendering tile having the dynamic size by using the information about the dynamic size, the entire portion of the primitive may be rendered via the one-time rendering process.

According to an embodiment of the inventive concept, after a controller of the cache 420 has read the information about the primitive from the external memory 30 and updated the information in the cache storage based on the information in the external memory 30, the graphics pipeline processor 510 may read the information about the primitive by accessing only the cache 420, without having to access the external memory 30 again. Accordingly, performing the rendering of the entire portion of the primitive via the one-time rendering process may reduce the bandwidth of the information about the primitive to be read from the external memory 30.

The graphics pipeline processor 510 may perform the rendering on the entire portion of the primitive via an execution of the rendering pipeline 512 by using the information about the dynamic size corresponding to the primitive. The graphics pipeline processor 510 may store the rendered primitive 513 in a tile buffer 530.

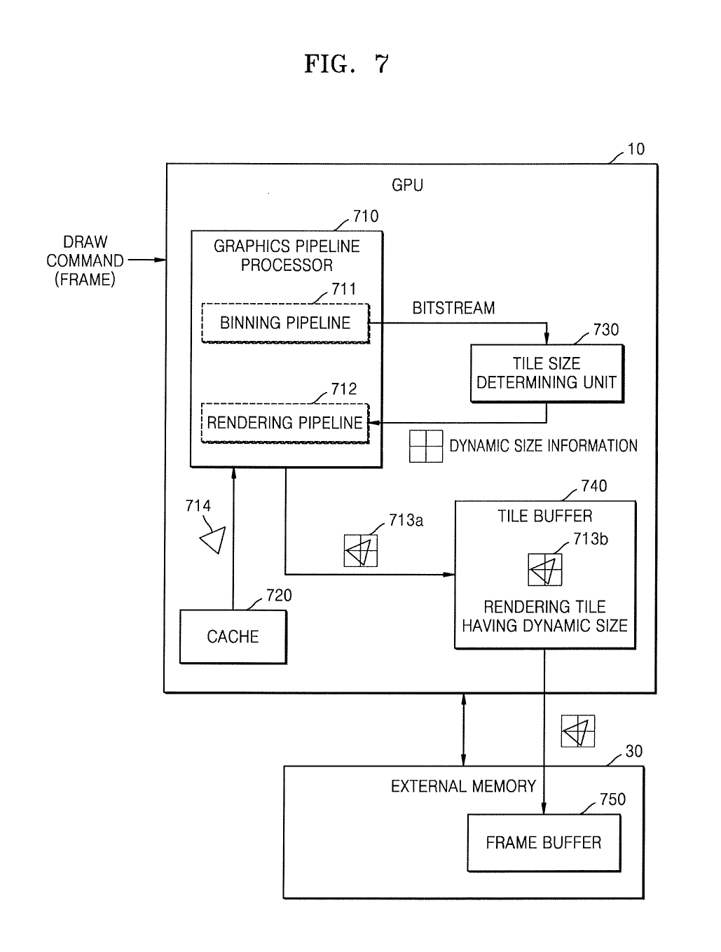

FIG. 6 is a diagram illustrating storing a rendered primitive in the external memory 30, according to an embodiment of the inventive concept.

Referring to FIG. 6, the entire portion of the primitive, which has been rendered by using the information about the dynamic size corresponding to the primitive in the graphics pipeline processor 12 of the GPU 10, may be stored in a tile buffer 610.

Since a capacity of the tile buffer 610 used as the on-chip memory may be limited, the rendering tile having the dynamic size may be determined, based on the capacity of the tile buffer 610. The tile size determining unit 520 may determine a capacity of the rendering tile having the dynamic size within a limited capacity of the tile buffer 610. For example, when a capacity of the tile buffer 610 is limited to a size of 32×32 tiles but the size of the primitive exceeds 32×32, the information about the dynamic size corresponding to the primitive may be adjusted to 32×32 so as not to exceed the capacity of the tile buffer.

In addition, the GPU 10 may access the external memory 30 and store (or write) a primitive 611a stored in the tile buffer 610, in a frame buffer 620 which is a storage space allocated in the external memory 30.

When at least one primitive is rendered per tile having a certain size in the graphics pipeline processor 12 of the GPU 10, at least one primitive which belongs to a tile having the certain size may be stored in the tile buffer 610. When the at least one primitive belonging to the tile, which is stored in the tile buffer 610 and has the certain size, is stored in the frame buffer 620, a portion of tiles having the initial size, which form the tile having the initial size, may not include any primitive. Thus, even when tiles having the initial size which include no primitive are stored in the frame buffer 620, the bandwidth may increase.

The GPU 10 may perform the rendering by using the dynamic size information corresponding to the primitive, which has been determined by the tile size determining unit 520, and store only the tiles including the primitive in the frame buffer 620. By using the dynamic size information corresponding to the primitive, the bandwidth, for example, an amount of the result of rendering to be stored in the frame buffer 620 allocated in the external memory 30, may be reduced.

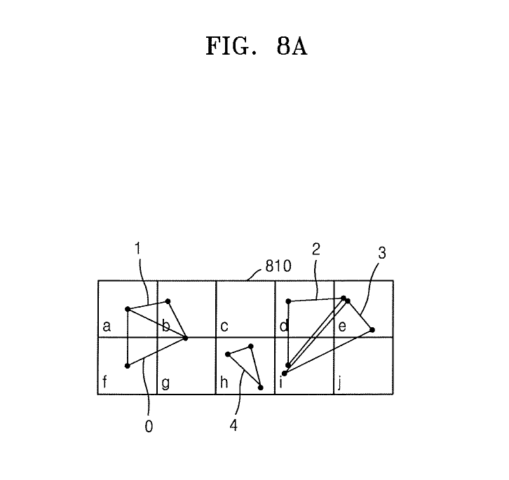

FIG. 7 is a diagram illustrating the TBR performed in the GPU 10 including a tile size determining unit 730, according to an embodiment of the inventive concept. A bitstream representing a result of the binning may be generated after the tile binning has been performed per initial tile having the initial size used to divide a frame in a binning pipeline 711 of a graphics pipeline processor 710. The bitstream may store the information about a primitive which belongs to each initial tile.

The tile size determining unit 730 may determine whether the primitive belonging to the initial tile also belongs to other initial tiles in addition to the initial tile by using the generated bitstream. One way such a determination may be made is based on the attributes of the vertices from which the primitive is generated. For example, if the primitive is triangular, there may be multiple vertices from which the triangle is generated, with certain texture coordinates, position, etc., or for example, there can be an array of indices that point to an array of vertices.

The tile size determining unit 730 may determine a rendering tile having the initial size which is formed of at least one initial tile that the primitive belongs to, based on a result of the determination. In addition, the tile size determining unit 730 may perform the rendering for the primitive included in the determined rendering tile per each determined rendering tile.

The tile size determining unit 730 may provide to the graphics pipeline processor 710 the dynamic size information corresponding to the rendering tile unit performing the rendering for the primitive. The graphics pipeline processor 710 may perform the rendering for each primitive per the rendering tile corresponding to respective primitives, based on the dynamic size information.

With continued reference to FIG. 7, the graphics pipeline processor 710 may access, for rendering respective primitives per the rendering tile, a cache 720 placed inside the GPU 10 instead of accessing the external memory 30, which results in an increased in speed. The cache 720 may store the information about the primitive already rendered by the graphics pipeline processor 710. When the graphics pipeline processor 710 needs the information about a primitive identical to the primitive recently rendered, the graphics pipeline processor 710 may rapidly read information about a primitive 714 by accessing the cache 720 instead of accessing the external memory 30.

The graphics pipeline processor 710 may perform the rendering for an entire portion of a primitive 713a after having executed a rendering pipeline 712 by using the dynamic size information corresponding to the primitive. After a controller of the cache 720 has read once the information about the primitive from the external memory 30 and updated the read information therein, the graphics pipeline processor 710 may read the information about the primitive by accessing only the cache 720 without accessing the external memory 30 again. Accordingly, performing the rendering for the entire portion of the primitive via the one-time rendering process may reduce the bandwidth of the information about the primitive to be read from the external memory 30.

The graphics pipeline processor 710 may store in a tile buffer 740 the primitive 713a rendered per the rendering tile having the dynamic size as depicted by primitive 713b.

The GPU 10 may access the external memory 30 and store (or write) a primitive 713b stored in the tile buffer 740, in a frame buffer 750 which is a storage space allocated in the external memory 30.

The GPU 10 may perform the rendering by using the dynamic size information corresponding to the primitive, which is determined by the tile size determining unit 730, and store only tiles including the primitive in the frame buffer 750. By using the dynamic size information corresponding to the primitive, the bandwidth, for example, an amount of the result of the rendering to be stored in the frame buffer 750 allocated in the external memory 30 may be reduced.

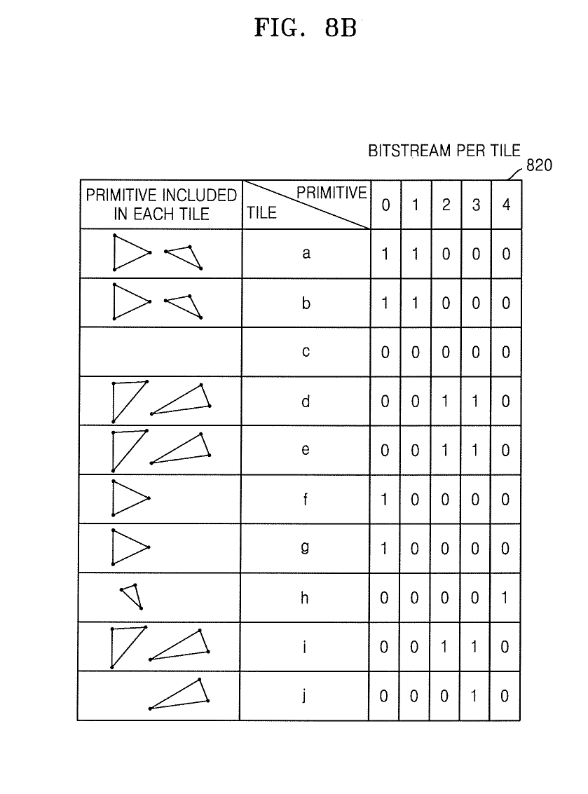

FIG. 8A is a diagram illustrating tiles and primitives for generating bitstreams, and FIG. 8B is a diagram illustrating bitstreams having information about primitives stored therein, according to embodiments of the inventive concept.

Referring to FIG. 8A, a frame 810 may be divided into ten tiles having the initial size (e.g. tiles a through j). A portion or an entirety of respective primitives (primitives 0 through 4) may belong to each of the ten tiles. In addition, there may be a tile (the tile c) which does not include any primitive. For example, the entire primitive 4 belongs to tile h, primitive 3 belongs to tiles d, e, l and j, and tile c does not include any primitive.

Referring to FIG. 8B, the GPU 10 may execute a binning pipeline and store information about primitives which belong to each tile in a tile-based bitstream 820. A bit value of 1 in the bitstream 820 may denote that a primitive is included in the tile and a bit value of 0 in the bitstream 820 may denote that the primitive is not included in the tile.

For example, referring to FIG. 8A, the primitives 0 and 1 belong to the tile a. Referring to a bitstream for the tile “a” in FIG. 8B, the bit values of the primitives 0 and 1 are all 1's, and the bit values of primitives 2, 3, and 4 are all 0's, and thus, it will be easily understood that the primitives 0 and 1 belong to the tile “a”.

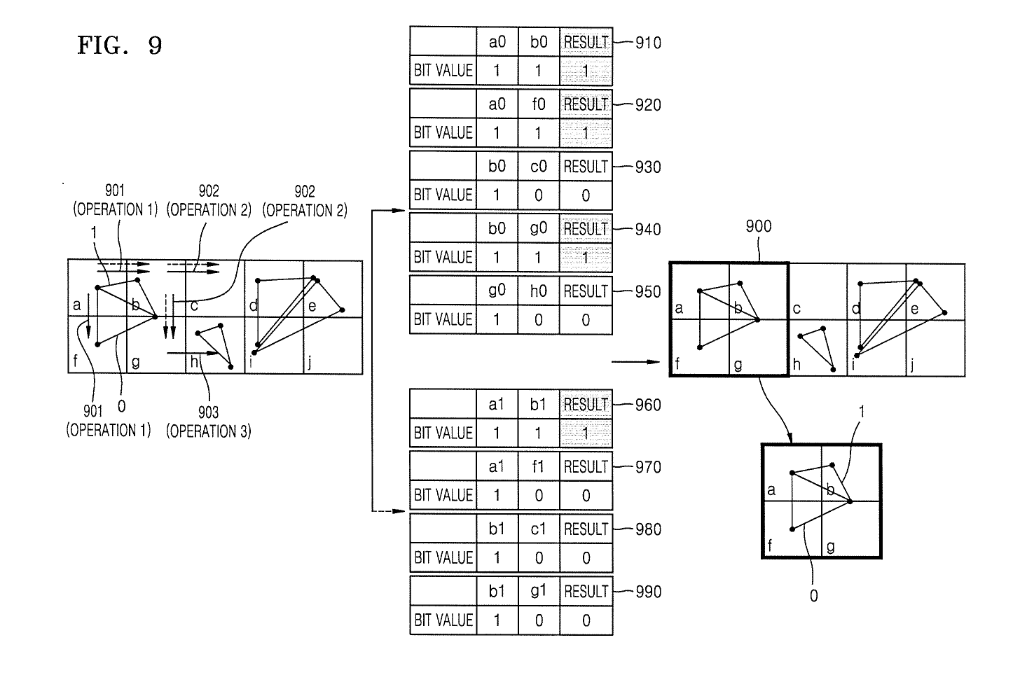

FIG. 9 is a diagram illustrating the determining of a dynamic size corresponding to a rendering tile unit, according to an embodiment of the inventive concept.

Referring to FIG. 9, a tile determining unit of the GPU 10 may determine through the use of a bitstream whether a primitive belonging to one initial tile belongs to other surrounding (e.g. bordering) initial tiles. Other initial tiles bordering the one initial tile may be neighboring tiles adjacent to the one initial tile. In addition, a tile determining unit may determine a rendering tile, having a dynamic size, which is formed of at least one initial tile that the primitive belongs to, based on a result of the determining. The following processes may be executed in the tile determining unit of the GPU. However, the present embodiment of the inventive concept is not limited thereto.

According to an embodiment of the inventive concept, a tile determining unit may determine an initial tile. The initial tile may be a tile having the initial size by which the frame is divided. In addition, the tile determining unit may select a primitive which belongs to the determined initial tile. For example, the initial tile may be any one of the tiles a through j. The tile determining unit may determine the tile “a” as being the initial tile and select a primitive 0 among the primitives 0 and 1.

According to an embodiment of the inventive concept, a tile determining unit may compare a bit value of an initial tile corresponding to a selected primitive and bit values of other initial tiles substantially surrounding (e.g. tiles next to the initial tile) the initial tile by using a bitstream. A person of ordinary skill in the art should understand that the term other initial tiles from which a bit value is compared are next to the original tile corresponding to the selective primitive, but the term “substantially surrounding” does not refer to a complete encirclement of the initial tile. For example, it can be seen in some of the examples that a block of initial tiles including the tile corresponding to the selected primitive are used for a comparison of bit values.

In addition, the tile determining unit may compare bit values, based on an AND operation. When the selected primitive belongs to other initial tiles as a result of comparing bit values, a rendering tile having a dynamic size may include the initial tile and other initial tiles. In addition, when the selected primitive does not belong to other initial tiles as a result of comparing bit values, the rendering tile having the dynamic size may include the initial tile but may not include other initial tiles.

According to an embodiment of the inventive concept, when a selected primitive is determined to belong to other initial tile, the other initial tile may be selected and the aforementioned processes may be repeated. In addition, the aforementioned processes may be repeated for a primitive which has not been selected among primitives that belong to the initial tile. However, the aforementioned processes may be omitted for the initial tiles already included in a rendering tile having a dynamic size. The dynamic size may become larger as repeated processes are executed, but the rendering tile having the dynamic size may be determined in view of a capacity of a tile buffer.

Referring to FIG. 9, “a0” and a bit value corresponding thereto listed in tables may be indices representing whether the primitive 0 belongs to the tile a. A case when the bit value corresponding to the “a0” is 1 may represent that the primitive 0 belongs to the tile a, and a case when the bit value corresponding to the “a0” is 0 may represent that the primitive 0 does not belong to the tile “a”.

Duplicate content in operations below will be omitted for the sake of convenience.

For example, a tile size determining unit may determine an initial tile as the tile “a”, and select a primitive 0 which belongs to the tile “a”.

In operation 1 (or process 901), the bit value of the tile “a” corresponding to the selected primitive 0 and respective bit values corresponding to the primitive 0 of other initial tiles, for example, the tiles b through j, surrounding the tile “a” may be compared. A result of an AND operation on the bit value of the tile “a” corresponding to the primitive 0, for example, 1 and the bit value of the tile “b” corresponding to the primitive 0, that is, 1 is 1 (process 901). In addition, a result of the AND operation on the bit value of the tile “a” corresponding to the primitive 0, that is, 1 and the bit value of the tile “f” corresponding to the primitive 0, that is, 1 is 1 also (process 902). Since the result of the AND operation on bit values are all 1's, the tile size determining unit may determine that the primitive 0 belongs to tile “b” and the tile “f”, and determine that a rendering tile having a dynamic size is a tile including the tiles a, b, and f. The aforementioned processes may be repeated for a primitive 1 which belongs to the tile “a”, but has not been selected. However, the aforementioned process for the primitive 1 may be omitted with respect to the tiles b and f which have been included in the rendering tile having the dynamic size.

In operation 2, the tile size determining unit may repeat the aforementioned processes by sequentially selecting each of the tiles b and f to which the primitive 0 belongs as a new initial tile, based on the result of operation1. The tile size determining unit may determine the tile b as an initial tile and select the primitive 0 which belongs to the tile “b”. A bit value of the tile b corresponding to the selected primitive 0 and respective bit values of other initial tiles surrounding the tile “b”, for example, the tiles c and g, may be compared. A result of the AND operation on the bit value of the tile “b” corresponding to the primitive 0, for example, 1 and the bit value of the tile c corresponding to the primitive 0, that is, 0 is 0 (process 930). In addition, a result of the AND operation on the bit value of the tile “b” corresponding to the primitive 0, that is, 1 and the bit value of the tile “g” corresponding to the primitive 0, that is, 1 is 1 (process 940). As a result of the AND operation on bit values, a rendering tile having a dynamic size may be determined not to include the tile c but to include the tile “g”. The aforementioned process may be omitted for the tile “f” which has been already determined to be included in the rendering tile having the dynamic size in operation 1.

In operation 3, the tile size determining unit may repeat the aforementioned processes by determining the tile “g” to which the primitive 0 belongs as a new initial tile, based on the result of operation 2. The tile size determining unit may determine the tile “g” as an initial tile and select the primitive 0 which belongs to the tile “g”. The bit value of the tile “g” corresponding to the selected primitive 0 and respective bit values of other initial tiles surrounding the tile g, for example, the tiles f and h, corresponding to the primitive 0 may be compared. However, the aforementioned processes may be omitted for the tile “f” which has been already determined to be included in the rendering tile having the dynamic size in operation 1. Since a result of the AND operation on the bit value of the tile “g” corresponding to the primitive 0, that is, 1 and the bit value of the tile “h” corresponding to the primitive 0, that is, 0 is 0 (process 950), the rendering tile having the dynamic size may not include the tile “h”.

Referring to FIG. 9, a rendering tile 900 having a dynamic size may be determined as a tile including the tiles a, b, f, and g, via operations 1 through 3. Operations 1 through 3 may be processes for determining the initial tiles to which the primitive 0 belongs, and additional processes may be performed for determining the initial tiles to which other primitives belong except the primitive 0 which belongs to the tiles a, b, f, and g that are included in the rendering tile 900 having the dynamic size. However, the additional processes may be omitted for the tiles (the tiles a, b, f, and g) which have been already determined to be included in the rendering tile 900 having the dynamic size.

For example, since the primitive 1 belongs to the rendering tile 900 having the dynamic size in addition to the primitive 0 used in operations 1 through 3, processes 960, 970, 980, and 990 may be performed for determining initial tiles to which the primitive 1 belongs. However, since the initial tiles to which the primitive 1 belongs, for example, the tiles a and b, have been already determined to be included in the rendering tile 900 having the dynamic size in operation 1, processes 960 through 990 may be omitted.

A tile size determining unit may determine the rendering tile 900 having the dynamic size, via operations 1 through 3. A graphics pipeline processor may perform rendering for the primitives 0 and 1 included in the rendering tile 900 per the rendering tile 900 having a determined dynamic size. Since the rendering tile 900 having the dynamic size includes entire portions of the primitives 0 and 1, the entire portions of the primitives 0 and 1 may be rendered via the one-time rendering process. Information about the primitives 0 and 1 may be read by accessing only a cache without accessing the external memory 30 again, via rendering for primitives per the rendering tile 900 having the dynamic size. In addition, since the rendering tile 900 having the dynamic size does not include a tile without a primitive (e.g. the rendering tiles each have a primitive), only the initial tiles having the primitives may be stored in a frame buffer.

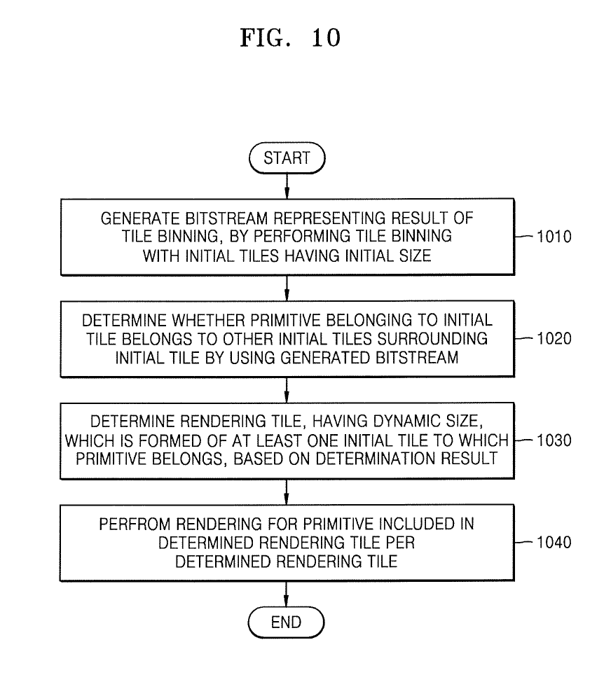

FIG. 10 is a flowchart of a method of performing the TBR in the GPU 10, according to an embodiment of the inventive concept.

In operation 1010, the GPU 10 may generate a bitstream representing a result of tile binning by performing the tile binning with initial tiles having an initial size in a binning pipeline. The bitstream may store information about primitives belonging to respective initial tiles.

In operation 1020, the GPU 10 may determine whether a primitive belonging to the initial tile belongs to other initial tiles substantially surrounding the initial tile by using the generated bitstream. For example, for a first initial tile “a” (such as shown in FIG. 8B), the bit values of 1 for the primitives belong to tile “a” and bit values of other primitives 0 do not belong to tile “a”. This determination can be made for the other initial tiles substantially surrounding the first initial tile. A person of ordinary skill in the art also understands that the bit values identified with a primitive belonging to an initial tile in this example is based on a value of “1” (e.g. logic high), but the inventive concept is not limited to this example. In operation 1030, the GPU 10 may determine a rendering tile, having a dynamic size, which is formed of at least one initial tile to which the primitive belongs, based on the result of the determining. The rendering tile having the dynamic size may include, for example, the initial tile and may include other initial tiles.

In operation 1040, the GPU 10 may perform rendering for the primitive included in the determined rendering tile per each determined rendering tile.

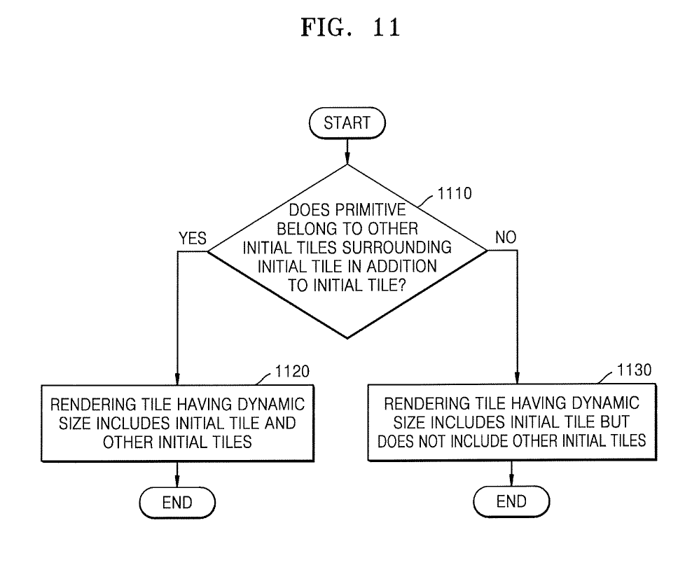

FIG. 11 is a flowchart of a method of determining a rendering tile having a dynamic size in a tile size determining unit, according to an embodiment of the inventive concept.

In operation 1110, the GPU 10 may determine whether a primitive belongs to other initial tiles surrounding the initial tile in addition to the initial tile. The GPU 10 may determine whether the primitive belongs to other initial tiles around (e.g. bordering) the initial tile, by comparing a bit value of the initial tile corresponding to the primitive and the bit values of other initial tiles, and by using a bitstream generated as a result of a binning pipeline.

In operation 1120, when the GPU determines that the primitive belongs to other initial tiles as a result of operation 1110, the rendering tile having the dynamic size may include both the initial tile and the other initial tiles to which the primitive belongs.

In operation 1130, when the primitive does not belong to other initial tiles as the result of operation 1110, the rendering tile having the dynamic size may include the initial tile but may not include other initial tiles.

A dynamic size may be variably determined depending on the number of initial tiles to which a primitive belongs and a rendering tile having a dynamic size may be determined, based on a capacity of a tile buffer.

The embodiments of the inventive concept may be realized in a form of a non-transitory computer readable recording medium including instructions executable by a computer, such as program modules executed by the computer. The non-transitory computer readable recording medium may include any available medium that can be accessed by the computer and may include any medium of volatile and nonvolatile media, and removable and non-removable media. In addition, the non-transitory computer readable medium may include computer storage media and communication media. The non-transitory computer readable storage medium may include any medium of volatile and nonvolatile media, and removable and non-removable media implemented by any method or technology for storing information such as computer readable instructions, data structures, program modules, and other data. The communication medium may generally include computer readable instructions, data structures, program modules, or other data in modulated data signals such as a carrier wave, or any other transfer mechanism, and any other information transfer medium.

It should be understood that embodiments of the inventive concept described herein should be considered in a descriptive sense only and not for purposes of limitation. Descriptions of features or aspects within each embodiment should typically be considered as available for other similar features or aspects in other embodiments.

Although the inventive concept has been particularly shown and described with reference to at least one exemplary embodiment thereof, it will be understood by a person of ordinary skill in the art that various changes in form and details may be made therein without departing from the spirit and scope of the inventive concept as defined by the appended claims. The exemplary embodiments should be considered in a descriptive sense only and not for purposes of limitation. Therefore, the inventive concept is defined not by the detailed description of the inventive concept but by the appended claims, and all differences within the scope will be construed as being included in the inventive concept.

While one or more embodiments of the inventive concept have been described with reference to the figures, it will be understood by those of ordinary skill in the art that various changes in form and details may be made therein without departing from the spirit and scope as defined by the following claims.

What is claimed is:

1. A method of performing tile-based rendering in a graphics processing apparatus, the method comprising:
performing tile binning with a plurality of initial tiles having initial sizes and generating a bitstream representing a result of the tile binning;
determining, based on the generated bit stream, whether a primitive belonging to a first initial tile of the plurality of initial tiles additionally belongs to other initial tiles bordering the first initial tile;
determining a rendering tile, having a dynamic size, which is formed by at least one of the plurality of initial tiles that the primitive belongs to, based on a result of whether the primitive additionally belongs other initial tiles bordering the first initial tile; and
performing rendering on the primitive included in the determined rendering tile, per each of the at least one of the initial tiles determined to form the rendering tile.

2. The method of claim 1, wherein the dynamic size of the rendering tile is variably determined depending on a number of initial tiles to which the primitive belongs.

3. The method of claim 1, wherein the determining of the rendering tile having the dynamic size comprises determining the dynamic size based on a capacity of a tile buffer.

4. The method of claim 1, wherein the determining of the rendering tile having the dynamic size includes adjusting the dynamic size of the rendering tile to be less than a capacity of a tile buffer.

5. The method of claim 1, wherein the determining, based on the generated bit stream, whether the primitive belonging to the first initial tile additionally belongs to other initial tiles bordering the initial tile includes comparing a bit value of the first initial tile corresponding to the primitive and bit values of the other initial tiles.

6. The method of claim 5, further comprising determining, as a result of the comparing of the bit value, that the primitive additionally belongs to the other initial tiles when a bit value of the other initial tiles respectively corresponds to the bit value of the primitive belonging to the first initial tile, and determining that the primitive belonging to the first initial tile does not belong to the other initial tiles when the bit value of the other initial tiles does not respectively correspond to the bit value of the primitive belonging to the first initial tile.

7. The method of claim 6, wherein the comparing is performed based on an AND operation performed on the bit values.

8. The method of claim 1, further comprising storing, in a frame buffer allocated in an external memory, a rendering result after the rendering on the primitive has been performed by using the rendering tile having the dynamic size.

9. A graphics processing apparatus performing tile-based rendering, the apparatus comprising:
an external memory configured to store information about primitives; and
at least one processor configured to:
generate a bitstream representing a tile binning result of a tile binning operation performed with respect to a plurality of initial tiles having initial sizes,
determine, based on the generated bitstream, whether a primitive belonging to a first initial tile additionally belongs to other initial tiles bordering the first initial tile
determine a rendering tile, having a dynamic size, which is formed by at least one of the initial tiles that the primitive belongs to, based on a result of the determination as to whether the primitive belonging to a first initial tile additionally belongs to other initial tiles bordering the first initial tile, and
perform rendering on the primitive included in the determined rendering tile, per each of the at least one of the initial tiles determined to form the rendering tile.

10. The apparatus of claim 9, wherein the dynamic size is variably determined depending on a number of initial tiles to which the primitive belongs.

11. The apparatus of claim 9, wherein the at least one processor is further configured to determine the rendering tile having the dynamic size, based on a capacity of a tile buffer.

12. The apparatus of claim 9, wherein the at least one processor is further configured to adjusting the dynamic size of the rendering tile to be less than a capacity of a tile buffer.

13. The apparatus of claim 9, wherein the at least one processor is further configured to determine by using the bitstream whether the primitive additionally belongs to other initial tiles, by comparing a bit value of the first initial tile corresponding to the primitive and the bit values of the other initial tiles.

14. The apparatus of claim 13, wherein the rendering tile having the dynamic size comprises the first initial tile and at least one of the other initial tiles when it is determined, as a result of the comparing of the bit value, that the primitive additionally belongs to at least one of the other initial tiles, and the dynamic size comprises only the first initial tile when it is determined, as a result of the comparing, that the primitive does not additionally belong to any of the other initial tiles.

15. The apparatus of claim 14, wherein the comparing is performed, based on an AND operation performed on the bit values.

16. The apparatus of claim 9, wherein the external memory is further configured to store, in a frame buffer allocated in the external memory, a rendering result after the rendering on the primitive has been performed by using the rendering tile having the dynamic size.

17. A non-transitory computer readable recording medium having recorded thereon a program for executing on a computer the method of claim 1.

18. A graphics processing apparatus, comprising:
a graphics processing unit (GPU) including an on-chip memory and a graphics pipeline processor comprising a binning pipeline and a rendering pipeline;
a central processing unit (CPU) that controls a graphics application programming interface (API) for the GPU; and
an external memory connected to the GPU;
wherein the binning pipeline is configured to divide an image frame including a primitive into a plurality of initial tiles and determine which of the initial tiles includes the primitive therein, and generate bitstream information about each of the plurality of initial tiles;
wherein the GPU renders the primitive included in the plurality of initial tiles and transforms a result of the rendered primitive into pixel expressions.
wherein the on-chip memory comprises a tile buffer in which the graphics pipeline processor stores the rendered primitive;
wherein the rendering pipeline is configured to perform rendering for each of the initial tiles and to determine a rendering tile formed of at least one of the plurality of initial tiles to which the primitive belongs, and
wherein the rendering tile has a dynamic size that is adjustable based on a number of the initial tiles to which the primitive belongs and a capacity of the tile buffer.

19. The graphics processing apparatus according to claim 18, wherein the external memory includes a frame buffer that stores the image frame; and
wherein the GPU performs the rendering of the primitive based on a dynamic size information corresponding to the primitive, and stores only the initial tiles including the primitive in the frame buffer.

20. The graphics processing apparatus according to claim 19, wherein the GPU further comprises a cache storage connected to the graphics pipeline processor, and when the cache storage stores information about a previously-rendered primitive, the GPU reads information from the cache storage and does not access the external memory.
